(19) United States
(12) Patent Application Publication
(10) Pub. No.: US 2016/0260129 A1
(43) Pub. Date: Sep. 8, 2016

(54) IDENTIFYING ASSOCIATIONS BETWEEN INFORMATION MAINTAINED BY AN AD SYSTEM AND INFORMATION MAINTAINED BY AN ONLINE SYSTEM

(71) Applicant: Facebook, Inc., Menlo Park, CA (US)

(72) Inventors: Aleksey Sergeyevich Fadeev, Seattle, WA (US); Stephane Taine, Issaquah, WA (US); Liang Xu, Bellevue, WA (US); Surupa Biswas, Bellevue, WA (US); Ram Srinivasan, Menlo Park, CA (US)

(21) Appl. No.: 14/641,256

(22) Filed: Mar. 6, 2015

(51) Int. Cl. G06Q 30/02; H04L 29/08; G06F 17/30

(52) U.S. Cl. CPC G06Q 30/0255; G06F 17/30876; G06F 17/30241; G06F 17/30867; G06F 17/3053; H04L 67/22

(57) ABSTRACT

Different online systems, such as an ad system or a social networking system, maintain different identifiers. An ad system identifies an association between an unsynced cookie maintained by an ad system and a user of the online system. The ad system identifies an overlap IP sequence including multiple occurrences of a user's user id and multiple occurrences of an unsynced cookie id in communications associated with an IP address over a given time period. The ad system determines an overlap score based on the identified overlap IP sequence. The overlap score determines how closely the unsynced cookie is associated with the user of the online system. The ad system determines whether the unsynced cookie id and the user id are associated with one another based on the overlap score. The ad system stores an association between the unsynced cookie and the user of the online system thereby generating a synced cookie.

### BACKGROUND

This disclosure relates generally to online systems utilizing different identifiers for their users to whom they serve content, and in particular to identifying associations between these different identifiers stored by the online systems, such as between identifiers stored by a social networking system and by an advertising (ad) system.

Online systems provide content to users of the online systems for the user to interact with and consume. For example, users of an online system may share their interests and engage with other users of the online system by sharing photos, real-time status updates, and playing social games. The online systems may maintain for each of the users of the online system an identifier identifying the user of the online system. An example of an online system is a social networking system. The online systems may log interactions of users with content presented to the user via the online system.

Advertising (ad) systems log various interactions of users with content presented to the user via the Internet, such as the user's webpage viewing history. The ad system may maintain identifiers identifying web traffic received from various devices used by users. For example, the ad system may maintain one identifier associated with a web browser executing on a user's desktop device, and may maintain a second identifier associated with an application executing on a user's mobile device.

Maintaining and tracking information associated with a user by the ad system is a particularly difficult task as users continue to consume greater amounts of content across various devices and applications. Further, associating an identifier with a particular individual is also challenging for the ad system given the rise in content and variety of content provided to and interacted with by a user across a variety of client devices. For example, it is difficult to link activities by a user on mobile devices with the user's web browsing on other types of devices. It is thus difficult to, for example, match an advertising impression on a mobile device for a user to a purchase of an advertised product or other conversion by the user on a web browser of a desktop computer.

### SUMMARY

A online system presents content items to a user of the online system for the user of the online system to consume. Examples of an online system include a social networking system, an advertisement (ad) system, web hosting and publishing services or any content delivering and monitoring system. A user of the online system may view the content provided by the online system via an application executing on the client device used by the user. As the user interacts with the content provided by the online system, the client device may communicate information to the online system. Examples of information communicated from the client device to the user of the online system include: an IP address associated with the client device of the user, a user id associated with the user of the online system and the time at which the communication was sent by the client device. In other examples, the communications may include additional information such as information identifying the location of the client device when the communication was sent or information identifying an action performed by the user with respect to the content presented to the user of the client device.

An ad system logs web traffic to web pages and mobile software applications associated with various advertisers, and stores the logged web traffic. The logged web traffic provides the ad system with information regarding the activities, interests, habits, and purchasing decisions of users of client devices. In one embodiment, the ad system logs the public IP (Internet Protocol) address of client devices accessing various web pages, such as pages associated with a variety of advertisers or other online systems such as the online system receiving assistance from the ad system. In one example, a user browses a web page and interacts with an advertisement via a web browser installed on the user's client device. The browser, responsive to the user interacting with an advertisement presented to the user via the client device, communicates the user's IP address, one or more cookies associated with the client device, the information included in the one or more cookies associated with the client device, the time at which the user interacted with the advertisement, and any other relevant information to the ad system.

Both the ad system and the online system monitor web activity of the user and maintain information associated with the user. The online system in particular includes information provided by the user or inferred by the online system that identifies the user, such as the name of the user or the user's contact information, the user's hobbies, likes and dislikes, etc. For example, a social networking system may have a user identifier that identifies the particular user and links him to his social networking identity or profile on the system. The ad system however, does not necessarily maintain information associated with the identity of the user but may monitor activity of a user on a client device via one or more cookies for example. In one embodiment, the ad system may leverage the identification information stored by the online system to associate a cookie or identifier stored by the ad system with a particular individual or user of the online system. Thus, by the two parties communicating, the ad system may more accurately be able to identify the user or individual associated with an identifier maintained and stored by the ad system 150. Similarly, the online system can have the advantage of linking its users to the advertising information available to the ad system.

In one embodiment, the online system identifies an association between an IP cluster and one or more users of an online system. By doing this, the ad system may link the web traffic and activity related to the IP cluster with a particular user or individual. For example, the ad system upon identifying that an IP cluster is associated with a user creates an association between an identifier identifying the user on the online system, information associated with the user on the online system, and one or more cookies maintained by the ad system that are frequently received from the IP cluster. Further, the association between an IP cluster and one or more users of an online system allows the online system or the ad system to identify various frequently used devices associated with a user of the online system. As described below the method is performed by the ad system, however in other embodiments, the method may be performed by other entities such as the online system.

The ad system retrieves activity logs identifying user activity associated with users of the online system, and identifies candidate IP clusters from the retrieved online system activity logs. The ad system identifies, for each IP address in the activity logs, the client devices associated with the IP address and the various times the client devices communicated with the online system using the IP address. The ad system identifies the usage time periods for each of the client devices associated with the IP address, and may then identify a candidate IP cluster by grouping the client devices associated with the IP address whose usage time periods overlap.

The ad system identifies one or more stable IP clusters from the previously identified candidate IP clusters. A stable IP cluster is an IP cluster that has been present in the retrieved activity logs for greater than a threshold period of time. The ad system identifies for each stable IP cluster a user of the online system associated with the stable IP cluster. The ad system may identify a user id associated with the client devices included in a stable IP cluster, and determine, from the identified user id, the user of the online system associated with the stable IP cluster. In another example, the ad system may identify the user id included in the communications received from the client devices behind the IP address associated with the IP cluster, and determine the user of the online system associated with the IP cluster from the identified user id.

The ad system stores an association between the user of the online system and a stable IP cluster. The ad system may also store an association between the user id of the user and each client device included in the stable IP cluster. This allows the ad system to identify client devices the user uses frequently and store an association between web traffic (i.e., cookies monitored and maintained by the ad system) received from the client devices in the IP cluster and the user of the online system 140.

In another embodiment, the ad system identifies an association between an unsynced cookie (an unsynced cookie being a cookie that has not been determined to be associated with any particular user of the online system) and a user of a online system. The association between an unsynced cookie and a user of the ad system allows the ad system and the online system to identify a user associated with the unsynced cookie thereby converting the unsycned cookie into a synced cookie. The ad system retrieves activity logs from the online system activity log and the ad system activity log.

The ad system identifies IP sequences associated with users of the online system based on the retrieved online system activity log. The user IP sequence represents the times at which the users communicated with the online system via a specific IP address over a given period of time. Thus, the user IP sequence is a sequence of user id occurrences, where each user id occurrence is associated with a time at which a communication associated with the user id was received. The user IP sequence may include multiple occurrences of a single user's user id over a given time period.

Similarly, the ad system identifies the IP sequences associated with unsynced cookies received by the ad system based on the retrieved ad system activity log. The unsynced cookie IP sequence represents the times at which the unsynced cookies associated with a specific IP address were received by the ad system over a given period of time. Thus, the unsynced cookie IP sequence is a sequence of unsynced cookie id occurrences, where each unsynced cookie id occurrence is associated with a time at which a communication associated with the unsynced cookie id was received. The unsynced cookie IP sequence may include multiple occurrences of a single unsynced cookie id over a given time period.

In one embodiment, the ad system, in addition to identifying a user IP sequence and an unsynced cookie IP sequence, generates an overlap IP sequence. The overlap IP sequence is a combination of the user IP sequence and the unsynced cookie IP sequence over a given period of time. For example, the ad system may combine or join the user IP sequence data and the unsynced cookie IP sequence data collected over the period of a specific day.

The ad system determines an overlap score based on the generated overlap IP sequence. The overlap score determines how closely the unsynced cookie is associated with a user of the online system. In one embodiment, the ad system determines the overlap score based on the number of times an unsynced cookie id and a user id co-occur on the same IP address during a given time period. For example, the ad system determines the overlap score by determining the number of times a user id and an unsynced cookie id co-occurred in the overlap IP sequence during a time period of a day.

In another embodiment, the ad system may determine a weighted overlap score based on the generated overlap IP sequence. In one example, the ad system weights or modifies the overlap score based on the number of users of the online system associated with the IP address within the time period of the overlap IP sequence. For example, if the overlap score is determined based on the number of times a user id and an unsynced cookie id co-occurred in the overlap IP sequence during the time period of a day, the ad system modifies the overlap score determined based on the number of distinct user ids present in the overlap IP sequence during the same time period of a day. In another example, the ad system modifies the overlap score based on the co-occurrence of the user id and the unsynced cookie id within the same portion of the given time period of the overlap IP sequence within which the overlap score is determined. For example, the ad system may modify the weight attributed to each co-occurrence of the user id and the unsynced cookie id in the overlap IP sequence if the co-occurrence occurred within the time span of an hour. In some embodiments, additional information from the activity log may be used to determine an overlap score for a user id and cookie id pair.

The ad system determines whether the unsynced cookie id and the user id are associated with one another based on the overlap score. For example, the ad system determines that the unsynced cookie (represented by the unsynced cookie id) and the user of the online system (represented by the user id) are associated with one another if the overlap score is greater than a threshold value.

The ad system may store an association between the unsynced cookie and the user of the online system thereby generating a synced cookie associated with the user of the online system. In one embodiment, the ad system stores an association between the user id of the user and the unsynced cookie id associated with the unsynced cookie in the online system activity log. The ad system may also store an association between the user and information associated with the unsynced cookie received from the ad system.

Identifying an IP cluster associated with a user of the online system allows the ad system to identify client devices associated with the user and to associate various cookies received from the IP cluster with the user. This allows the ad system to better target content provided to a client device based on cookies or information received from the client device as the ad system is now aware of a user associated with the client device or the traffic received from the client device. By creating an association between an unsynced cookie and a user of the online system the ad system is able to identify a particular individual to associate with the unsynced cookie. The ad system may then supplement information associated with the unsynced cookie with information associated with the user determined to be associated with the unsynced cookie. Further, the ad system is aware of the identity of the individual associated with the web traffic logged and maintained by the ad system as determined from the unsynced cookie. The ad system may then be able to better target content to provide to a client device associated with the unsynced cookie and may further be able to associate conversions monitored by the unsynced cookie with the user determined to be associated with the unsynced cookie. Thus, by associating an IP cluster with a user and identifying cookies or web traffic associated with a user the ad system is able to link activities by a user on mobile devices with the user's web browsing on other types of devices. It is thus possible to, for example, match an advertising impression on a mobile device for a user to a purchase of an advertised product or other conversion by the user on a web browser of a desktop computer.

### BRIEF DESCRIPTION OF THE DRAWINGS

FIG. 1 is a block diagram of a system environment in which an online system and an ad system operates, in accordance with an embodiment of the invention.

FIG. 2 is an example of an IP cluster interacting with the ad system and the online system, according to one embodiment.

FIG. 3 is an example diagram illustrating communications between the user and the ad system or the online system over different periods of time, according to one embodiment.

FIG. 4A is an example block diagram of an architecture of the online system, according to one embodiment.

FIG. 4B is an example block diagram of an architecture of the ad system, according to one embodiment.

FIG. 5 is a flowchart describing a method for identifying an association between an IP cluster and one or more users of an online system 140, according to one embodiment.

FIG. 6 is a flowchart describing a method for identifying an association between an unsynced cookie and a user of an online system, according to one embodiment.

FIG. 7 is a flowchart describing a method for identifying an association between two cookies received by the ad system, according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

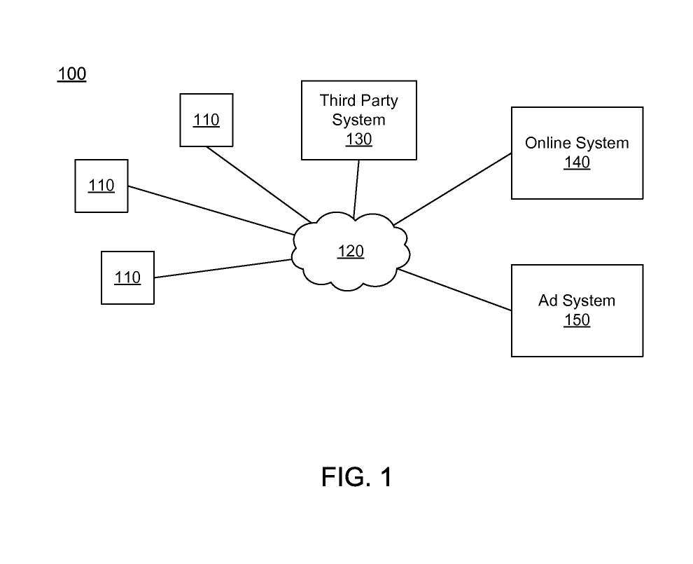

FIG. 1 is a high level block diagram of a system environment 100 for a online system 140. The system environment 100 shown by FIG. 1 comprises one or more client devices 110, a network 120, one or more third-party systems 130, an advertisement (ad) system 150 and an online system 140. In alternative configurations, different and/or additional components may be included in the system environment 100. The embodiments described herein can be adapted to online systems that are not online systems or advertising systems.

The client devices 110 are one or more computing devices capable of receiving user input as well as transmitting and/or receiving data via the network 120. In one embodiment, a client device 110 is a conventional computer system, such as a desktop or laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™. In a third embodiment, a client device 110 executes an online system application that interacts with the online system 140 thereby allowing the user of the client device 110 to perform various tasks supported by the online system 140. In other examples, the client devices 110 may provide content received from third party systems 130 or the ad system 150 to the users of the client devices 110.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

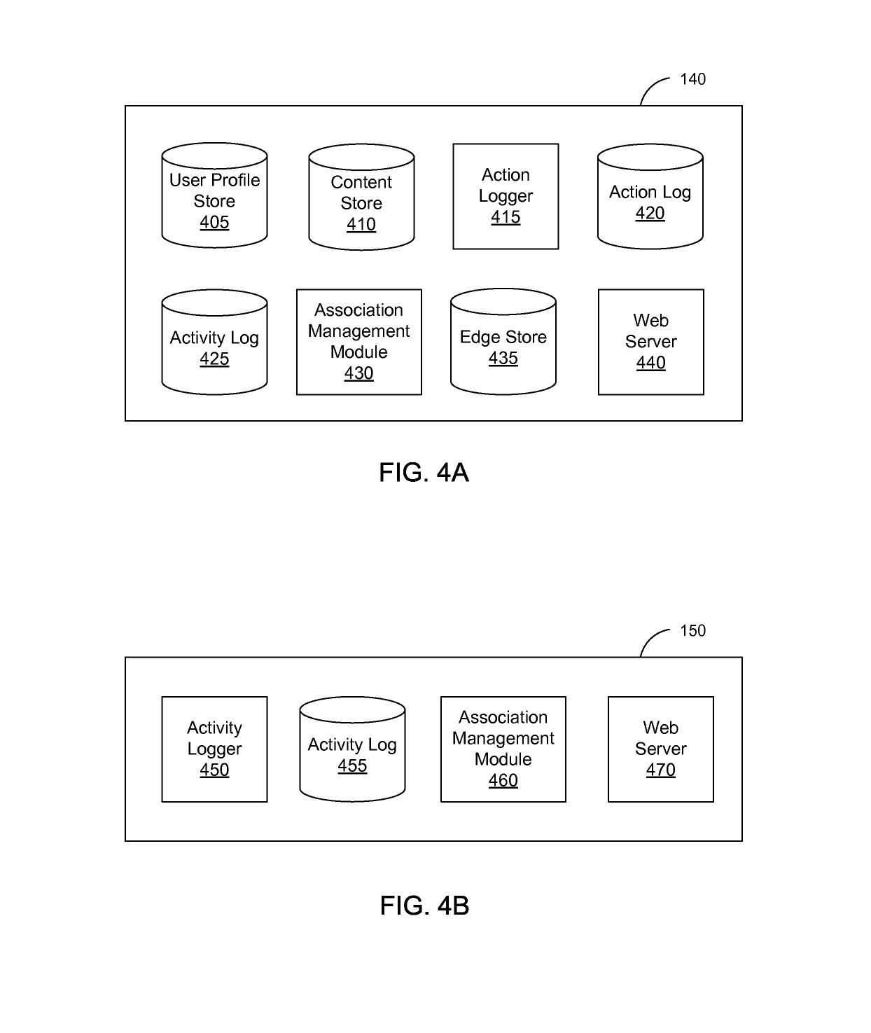

One or more third party systems 130 may be coupled to the network 120 for communicating with the online system 140 or the ad system 150, which are further described below in conjunction with FIG. 4A and FIG. 4B. In one embodiment, a third party system 130 is an application provider communicating information describing applications for execution by a client device 110 or communicating data to client devices 110 for use by an application executing on the client device 110. In other embodiments, a third party system 130 provides content or other information for presentation via a client device 110. A third party website 130 may also communicate information to the online system 140, such as advertisements, content, or information about an application provided by the third party website 130. Similarly, the third party system 130 communicates information to the ad system 150 regarding advertisements or content provided by the third party system 130 including cookies or other objects generated by a client device 110.

Advertisers (parties associated with third party systems 130) and other entities with an online presence (including the online system 140) create ad content to be provided for display within ad spaces on web pages and within mobile applications. An advertiser in one example may provide the online system 140 with an advertisement to present to users of the online system 140. Alternatively, the advertiser may provide another online system, such as a third party system 130 with an advertisement to present to the user of the online system. Advertisers purchase ad space in order to help drive user traffic to their own web pages and servers. For example, provided ad instances may include computer code that redirects the client device 110 to load content from the advertiser's web server responsive to receiving an interaction (e.g., a touch input) that corresponds to the provided ad instance. This may be simply a web address, or a more sophisticated algorithm. Advertisers use their web pages to promote and/or sell goods or services to users. In some instances, if an external web page contains ad content, the provided web page will include computer code indicating where the advertiser's ad content can be obtained.

Generally, the ad system 150 helps advertisers target users to whom to display their advertisements and the advertiser will often work with the ad system 150 to determine an ad campaign strategy suitable for the advertiser. In one embodiment, the ad system 150 is a collection of one or more ad servers and other components and entities. The ad system 150 logs web traffic to web pages and mobile software applications associated with various advertisers, and stores the logged web traffic. The logged web traffic provides the ad system 150 with information regarding the activities, interests, habits, and purchasing decisions of users of client devices 110. The ad system 150 processes this information to assist advertisers. In one embodiment, the ad system 150 logs the public IP (Internet Protocol) address of client devices 110 accessing various web pages, such as pages associated with a variety of advertisers or other online systems such as the online system 140 receiving assistance from the ad system 150. In one example, as a user browses a web page and interacts with an advertisement via a web browser installed on the user's client device 110, the browser, responsive to the user interacting with an advertisement on the client device 110, communicates the user's IP address, one or more cookies associated with the client device 110, the information included in the one or more cookies associated with the client device 110, the time at which the user interacted with the advertisement, and any other relevant information to the ad system 150.

Apart from receiving information from the client devices 110, the ad system 150 may also communicate with the online system 140. For example, the ad system 150 may leverage information associated with a user stored by the online system 140 to identify clusters of client devices 110 associated with an IP address for example. Alternatively, the ad system 150 may leverage the user information collected by the online system 140 to create associations between cookies logged by the ad system 150 and users of the online system 140.

One example of an online system 140 is a social networking system. The online system 140 maintains information about users of the online system 140 including information identifying the user, tastes and preferences of the user and other users of the online system 140 to which the user is connected. The online system 140 presents content items to a user of the online system 140 via a news feed for example. Content items presented include sponsored content items such as advertisements as well as non-sponsored content items such as images or text generated by users of the online system 140. The online system 140 maintains for each user an identifier such as a user id identifying the user, thereby allowing the online system 140 to monitor actions of the user on the online system 140. The online system 140 may also collect additional information associated with a user such as an identifier identifying a client device 110 associated with the user, an IP address associated with a user's client device 110, likes and preferences of users of the online system 140 or connections between users of the online system 140.

Both the ad system 150 and the online system 140 monitor web activity of the user and maintain information associated with the user. The online system 140 in particular includes information provided by the user or inferred by the online system 140 that identifies the user, such as the name of the user or the user's contact information. The ad system 150 however, does not necessarily maintain information associated with the identity of the user but may monitor activity of a user on a client device 110 via one or more cookies for example. In one embodiment, the ad system 150 may leverage the identification information stored by the online system 140 to associate a cookie or identifier stored by the ad system 150 with a particular individual or user of the online system 140. Thus, by communicating with the online system 140 the ad system 140 may more accurately be able to identify the user or individual associated with an identifier maintained and stored by the ad system 150.

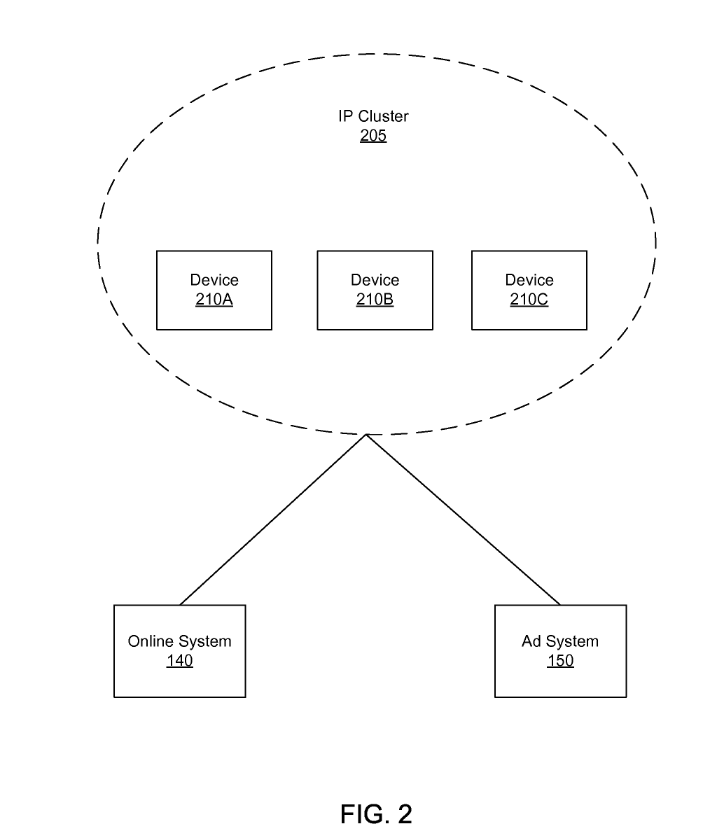

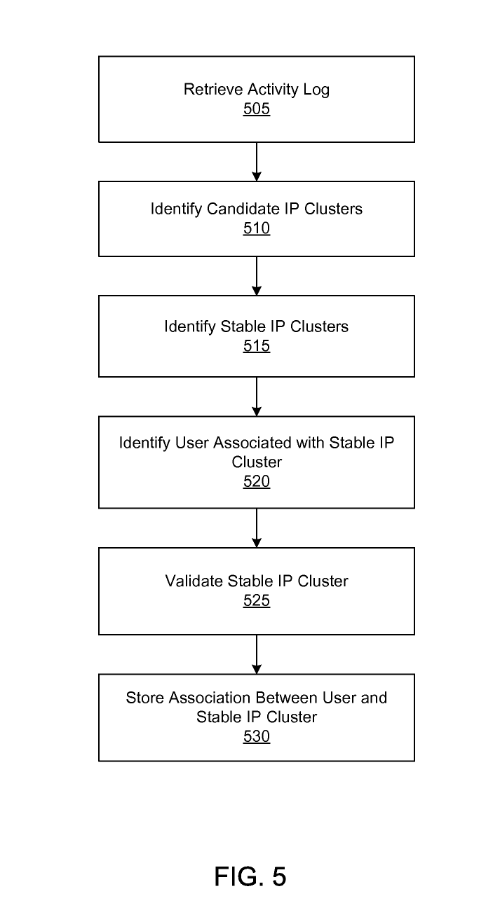

FIG. 2 is an example of an IP cluster interacting with the ad system and the online system, according to one embodiment. An IP (Internet Protocol) cluster 205 is a group of client devices 110 as shown in FIG. 1, or applications such as browsers executing on a client device 110, that share the same public IP address during a given time span. In the example of FIG. 2, the client devices are referred to as device 210A, device 210B, and device 210C (collectively referenced as device 210), are included in the IP cluster 205. Thus, devices 210A, 210B, and 210C all share the same public IP address for a given time span and form an IP cluster 205. An IP cluster 205 may be uniquely identified based on the public IP address associated with various devices 210 and usage times associated with various devices 210. For example, devices 210 having a similar public IP address and overlapping usage time periods are identified as an IP cluster 205, as is further described in conjunction with FIG. 5 below.

Devices 210 in an IP cluster 205 may communicate various kinds of information with the online system 140 as well as the ad system 150. For example, a device 210 in an IP cluster 205 may communicate the public IP address of the device 210 as well as the user id of the user accessing or interacting with the online system 140 via an application executing on the device 210. Further, the device 210 may also communicate usage time information associated with the user using the device 210, such as the time at which the user first accessed the online system 140 during a session, or the time at which a user last interacted with the online system 140 via the device 210. Alternatively, the online system 140 may monitor the various actions performed by a user to determine the time at which different actions are performed by the user during a given interaction session. In one example, the devices 210 send communications to the online system 140 responsive to receiving interactions associated with content provided by the online system 140. The communications may include the user id associated with the user of the device 210, a client device 110 identifier identifying the device 210 used by the user, the IP address used by the client device 110 to communicate with the online system 140, information associated with the interaction performed by the user, the time at which the user performed the interaction, and any additional information such as a geo-location value identifying the location of the device 210 when the user performed the user interaction. In some cases, the online system 140 determines certain of this information rather than receiving it from the device 210. For example, the system 140 may determine and log the time and date associated with the action.

Similarly the IP cluster 205 also communicates with the ad system 150. A device 210 in an IP cluster 205 may transmit a variety of information to the ad system 150. For example, the device 210 in the IP cluster 205 transmits the IP address of the device 210 and the IP cluster 205, the time at which the user began a browsing session on the IP address, or one or more cookies on the device 210. The device 210 may communicate information with the ad system 150 responsive to receiving a user interaction with content received from a third party system 130, the ad system 150 or the online system 140, such as responsive to the user viewing content during a browsing session. In one example, a device 210 in the IP cluster 205 sends information associated with one or more cookies to the ad system 150, including the cookie ids identifying the one or more cookies, the time at which the user interacted with content, and additional information such as a geo-location value identifying the location of the device 210 when the user interacted with the content. In some cases, the ad system 150 determines certain portions of this information rather than receiving it from the device 210, such as the time and date associated with the action. In other examples, the a device 210 in the IP cluster 205 sends device attributes, such as screen size of the device 210, memory of the device 210, the CPU of the device 210, or a device identifier.

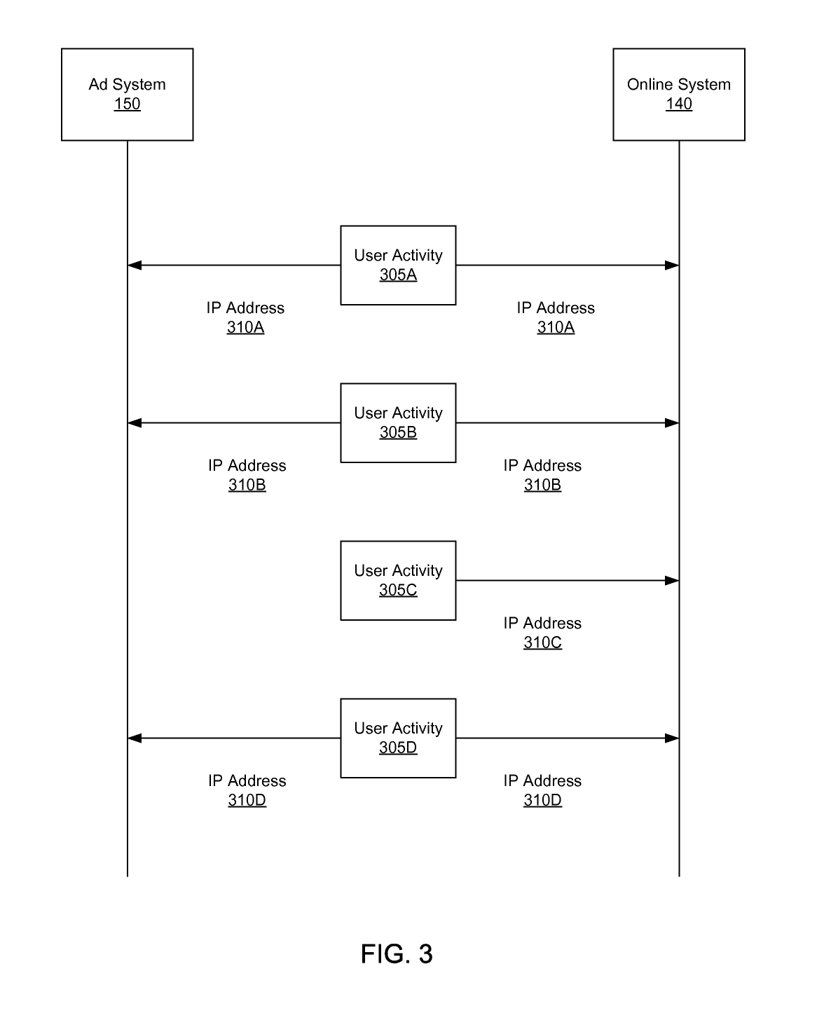

FIG. 3 is an example diagram illustrating communications between the user and the ad system or the online system over different periods of time, according to one embodiment. The user via one or more applications executing on the client device 110 may communicate with the online system 140 and the ad system 150 over different periods of time, such as during the course of a day. The communications to the online system 140 and the ad system 150 may overlap during certain portions of a period of time. For example, the user communicates with the online system 140 during the time periods of 10 AM-12 PM and 2 PM-4 PM of a particular day, and with the ad system 150 during the time periods of 10 AM-12 PM during the same day. In one embodiment, the public IP address of the client device 110 is included in the communications between the client device 110 and the online system 140 and the communications between the client device 110 and the ad system 150.

In the example of FIG. 3, the user performs a sequence of interactions on the client device 110 resulting in a sequence of IP address communications being communicated to the online system 140 and the ad system 150 during different periods of time. The user performs one or more user activities 305A resulting in the communication of an IP address 310A during a first period of time to both the ad system 150 and the online system 140. The user may then perform a different set of user activities during a second period of time resulting in the communication of IP address 310B to both the ad system 150 and the online system 140. The IP address 310B may be different from the IP address 310A. During a third period of time the user may interact with the client device 110 performing user activities 305C resulting in the communication of IP address 310C to the online system 140 alone and not the ad system 150. For example, the user may in the third period of time only interact with content provided by the online system 140.

During a fourth period of time the user may perform a user activity 305D resulting in the communication of IP address 310D to both the online system 140 and the ad system 150. Thus, as shown in the example of FIG. 3 the user may interact with a variety of content presented to the user via the client device 110. As the user interacts with the different content, the IP address 310 associated with the user at the time of the interaction is communicated to either the online system 140 or the ad system 150 or to both, depending, for example, on the content with which the user interacted. Therefore, there exist overlapping periods of time within which the IP address of the user during the period of time is communicated to both the online system 140 and the ad system 150. In addition to communicating the IP address 310 associated with the user, the client device 110 may also communicate unique cookies associated with the user, the user id associated with the user on the online system 140 and time information identifying the time at which the IP address was communicated by the client device 110. In some cases, the online system 140 or ad system 150 determines certain of this information rather than receiving it from the client device 110.

FIG. 4A is an example block diagram of an architecture of the online system. The online system 140 shown in FIG. 4A includes a user profile store 405, a content store 410, an action logger 415, an action log 420, an activity log 425, an association management module 430, a communication module 435, an edge store 440, and a web server 445. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 405. A user profile includes declarative information about the user that was explicitly shared by the user and may also include profile information inferred by the online system 140. In one embodiment, a user profile includes multiple data fields, each describing one or more attributes of the corresponding user of the online system 140. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with identification information of users of the online system 140 displayed in an image. A user profile in the user profile store 405 may also maintain references to actions by the corresponding user performed on content items in the content store 410 and stored in the action log 420. Further, a user profile in the user profile store 405 includes a user id identifying the user associated with the user profile.

While user profiles in the user profile store 405 are frequently associated with individuals, allowing individuals to interact with each other via the online system 140, user profiles may also be stored for entities such as businesses or organizations. This allows an entity to establish a presence on the online system 140 for connecting and exchanging content with other online system users. The entity may post information about itself, about its products or provide other information to users of the online system using a brand page associated with the entity's user profile. Other users of the online system may connect to the brand page to receive information posted to the brand page or to receive information from the brand page. A user profile associated with the brand page may include information about the entity itself, providing users with background or informational data about the entity.

The content store 410 stores objects that each represent various types of content. Examples of content represented by an object include a page post, a status update, a photograph, a video, a link, a shared content item, a gaming application achievement, a check-in event at a local business, a brand page, or any other type of content. Online system users may create objects stored by the content store 410, such as status updates, photos tagged by users to be associated with other objects in the online system, events, groups or applications. In some embodiments, objects are received from third-party applications or third-party applications separate from the online system 140. In one embodiment, objects in the content store 410 represent single pieces of content, or content “items.” Hence, users of the online system 140 are encouraged to communicate with each other by posting text and content items of various types of media through various communication channels. This increases the amount of interaction of users with each other and increases the frequency with which users interact within the online system 140. In one embodiment, the content store 410 includes both sponsored content items, such as advertisements, as well as non-sponsored content items, such as images generated by a user of the online system 140.

The action logger 415 receives communications about user actions internal to and/or external to the online system 140, populating the action log 420 with information about user actions. Examples of actions include adding a connection to another user, sending a message to another user, uploading an image, reading a message from another user, viewing content associated with another user, attending an event posted by another user, among others. In addition, a number of actions may involve an object and one or more particular users, so these actions are associated with those users as well and stored in the action log 420.

The action log 420 may be used by the online system 140 to track user actions on the online system 140, as well as actions on third party systems 130 that communicate information to the online system 140. Users may interact with various objects on the online system 140, and information describing these interactions are stored in the action log 410. Examples of interactions with objects include: commenting on posts, sharing links, and checking-in to physical locations via a mobile device, accessing content items, and any other interactions. Additional examples of interactions with objects on the online system 140 that are included in the action log 420 include: commenting on a photo album, communicating with a user, establishing a connection with an object, joining an event to a calendar, joining a group, creating an event, authorizing an application, using an application, expressing a preference for an object (“liking” the object) and engaging in a transaction. Additionally, the action log 420 may record a user's interactions with advertisements on the online system 140 as well as with other applications operating on the online system 140. In some embodiments, data from the action log 420 is used to infer interests or preferences of a user, augmenting the interests included in the user's user profile and allowing a more complete understanding of user preferences.

The action log 420 may also store user actions taken on a third party system 130, such as an external website, and communicated to the online system 140. For example, an e-commerce website that primarily sells sporting equipment at bargain prices may recognize a user of a online system 140 through a social plug-in enabling the e-commerce website to identify the user of the online system 140. Because users of the online system 140 are uniquely identifiable, e-commerce websites, such as this sporting equipment retailer, may communicate information about a user's actions outside of the online system 140 to the online system 140 for association with the user. Hence, the action log 420 may record information about actions users perform on a third party system 130, including webpage viewing histories, advertisements that were engaged, purchases made, and other patterns from shopping and buying.

In one embodiment, the action logger 415 receives communications including an IP address associated with the client device 110 of the user, a user id associated with the user of the client device 110 and the time at which the communication was sent by the client device 110 or received by the online system 140, and populates the activity log 425 with the information included in the received communications. In some examples, the action logger 415 may also include action information stored in the action log 420 in the activity log 425 and associate the action information with the various communications and user information stored in the activity log 425. Thus, the activity log 425 includes information describing the various communications received by the online system 140 from various client devices 110 communicating with the online system 140.

An association management module 430 creates and manages associations between different entities, objects, users, and information of the online system 140. In one embodiment, the association management module 430 identifies, from information included in the activity log 425, an association between a user of the online system 140 and an IP address. In another example, the association management module 430 identifies, from the information included in the activity log 425, an association between a user of the online system 140 and an IP cluster including a plurality of devices as is described in conjunction with FIG. 5 below. The association management module 430 may store the associations in the activity log 425 or the user profile store 405.

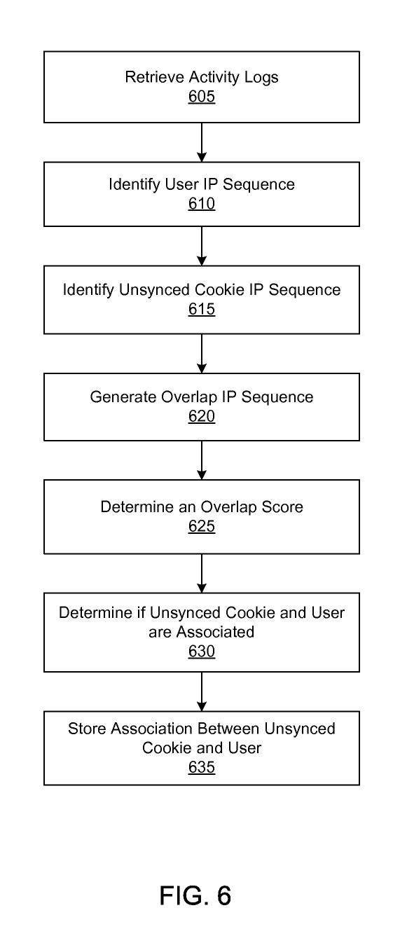

In one embodiment, the association management module 430 may communicate with the ad system 150 to identify an association between an unsynced cookie received by the ad system 150 and a user of the online system 140 as is further described below in conjunction with FIG. 6. The association management module 430 may identify an association between an unsynced cookie and a user of the online system 140 based on an IP address associated with the various communications received by the online system 140 including information about the user, such as the user id of the user, and communications received by the ad system 150 including information about the unsynced cookie, such as the unsynced cookie id identifying the unsynced cookie. By identifying an association between an unsynced cookie provided by the ad system 150 and a user of the online system 140, the association management module 430 is able to further identify information associated with the user, such as the client device 110 associated with the unsynced cookie or the information stored by the ad system 150 that is associated with the unsynced cookie. The association management module 430 may store the association between an unsynced cookie and the user of the online system in the activity log 425 or the user profile store 405.

In one embodiment, an edge store 435 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system, sharing a link with other users of the online system, and commenting on posts made by other users of the online system.

In one embodiment, an edge may include various features each representing characteristics of interactions between users, interactions between users and object, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 435 also stores information about edges, such as affinity scores for objects, interests, and other users. Affinity scores, or “affinities,” may be computed by the online system 140 over time to approximate a user's affinity for an object, interest, and other users in the online system 140 based on the actions performed by the user. A user's affinity may be computed by the online system 140 over time to approximate a user's affinity for an object, interest, and other users in the online system 140 based on the actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 435, in one embodiment. Alternatively, each interaction between a user and a specific object is stored as a separate edge. In some embodiments, connections between users may be stored in the user profile store 405, or the user profile store 405 may access the edge store 435 to determine connections between users.

The web server 440 links the online system 140 via the network 120 to the one or more client devices 110, as well as to the one or more third party systems 130, and the ad system 150. The web server 140 serves web pages, as well as other web-related content, such as JAVA®, FLASH®, XML and so forth. The web server 440 may receive and route messages between the online system 140 and the client device 110, for example, instant messages, queued messages (e.g., email), text messages, short message service (SMS) messages, or messages sent using any other suitable messaging technique. A user may send a request to the web server 440 to upload information (e.g., images or videos) that are stored in the content store 410. Additionally, the web server 440 may provide application programming interface (API) functionality to send data directly to native client device operating systems, such as IOS®, ANDROID™, WEBOS® or RIM®.

FIG. 4B is an example block diagram of an architecture of the ad system. The ad system 150 shown in FIG. 4B includes an activity logger 450, an activity log 455, an association management module 460 and a web server 470. In other embodiments, the ad system 150 may include additional, fewer, or different components for various applications. Conventional components such as network interfaces, security functions, load balancers, failover servers, management and network operations consoles, and the like are not shown so as to not obscure the details of the system architecture.

The activity logger 450 receives communications about user activity on third party systems 130 and the online system 140. Examples of user activity include viewing a web page hosted by a third party system 130, interacting with content provided by the online system 140 or a third party system, interacting with one or more advertisements, purchasing different items or products, and clicking or interacting with various interfaces provided by a third party system 130.

In one embodiment, the activity logger 450 receives communications including an IP address associated with the client device 110, one or more cookies stored on the client device 110, a cookie id identifying the one or more cookies, action information describing an activity or action performed by a user, and time information describing the time at which the communication was sent from the client device 110 and populates the activity log 455 with the information included in the received communications. Thus, the activity log 455 includes information describing the various communications received by the ad system 150 from various client devices 110 communicating with the ad system 150.

An association management module 460 creates and manages associations between different cookies and information stored by the ad system 150. In one embodiment, the association management module 460 may communicate with the online system 140 to identify an association between an unsynced cookie received by the ad system 150 and a user of the online system 140 as is further described below in conjunction with FIG. 6. The association management module 460 may identify an association between an unsynced cookie and a user of the online system 140 based on an IP address associated with the various communications received by the online system 140 including information about the user, such as the user id of the user, and communications received by the ad system 150 including information about the unsynced cookie, such as the unsynced cookie id identifying the unsynced cookie. By identifying an association between an unsynced cookie received by the ad system 150 and a user of the online system 140 the association management module 460 is able to further identify information associated with the unsynced cookie, such as the client device 110 associated with the user of the online system 140 or the information stored by the online system 140 that is associated with the user such as preferences of the user or connections of the user. The association management module 460 may store the association between an unsynced cookie and the user of the online system in the activity log 455.

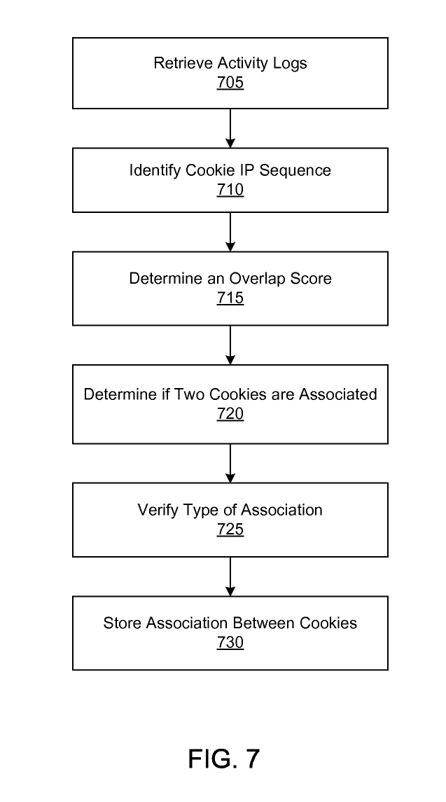

In one embodiment, the association management module 460 identifies an association between two cookies stored in the activity log 455 as is further described in conjunction with FIG. 7 below. The association management module 460 may identify an association between two cookies based on an IP address associated with the two cookies and the time at which communications including the two cookies are received from the client device using the IP address. The association management module 460 stores the association identified between two cookies in the activity log.

The web server 470 links the ad system 150 via the network 120 to the one or more client devices 110, as well as to the one or more third party systems 130, and the online system 140. The web server 140 serves web pages, as well as other web-related content, such as JAVA®, FLASH®, XML and so forth. The web server 470 may receive and route messages between the ad system 150 and the client device 110, for example. A client device 110 may send a communication to the web server 470 to store a cookie in the activity log 455. Additionally, the web server 470 may provide application programming interface (API) functionality to send data directly to native client device operating systems, such as IOS®, ANDROID™, WEBOS® or RIM®.

Identifying a User Associated with an IP Cluster

FIG. 5 is a flowchart describing a method for identifying an association between an IP cluster and one or more users of an online system. By creating an association between an IP cluster and one or more users of an online system 140 the ad system 150 may link the web traffic and activity related to the IP cluster with a particular user or individual. For example, the ad system 150 upon identifying that an IP cluster is associated with a user creates an association between an identifier identifying the user on the online system 140, information associated with the user on the online system 140 and one or more cookies maintained by the ad system 150 that are frequently received from the IP cluster. Further, the association between an IP cluster and one or more users of an online system 140 allows the online system 140 or the ad system 150 to identify various frequently used devices 110 associated with a user of the online system 140. As described below the method is performed by the ad system 150, however in other embodiments, the method may be performed by other entities such as the online system 140.

The ad system 150 retrieves 505 activity logs from the online system activity log 420. In particular, the ad system 150 retrieves IP address information, client device 110 identifier information, and time information associated with the IP address information and client device 110 identifiers included in the online system 140 activity log 420. Further, the ad system 150 also retrieves the user id associated with each communication from a client device 110 behind an IP address from the online system 140 activity log 420.

The ad system 150 identifies 510 candidate IP clusters from the retrieved online system activity log 420. The ad system 150 identifies, for each IP address in the activity log 420, the client devices 110 associated with the IP address and the various times the client devices 110 communicated with the online system 140 using the IP address. The ad system 150 identifies the usage time periods for each of the client devices 110 associated with the IP address. For example, the ad system 150 identifies a usage start time and a usage end time observed for each client device 110 associated with the IP address and determines from the usage start time and the usage end time a usage time period for each client device 110 behind the IP address. The ad system 150 may then identify 510 a candidate IP cluster by grouping the client devices 110 associated with the IP address whose usage time periods overlap.

The ad system 150 identifies 515 one or more stable IP clusters from the previously identified candidate IP clusters. A stable IP cluster is an IP cluster that has been present in the retrieved activity logs for greater than a threshold period of time. In one embodiment, the threshold period of time is configurable and can be modified, by a user authorized by the ad system 150 for example. In one example, the ad system 150 identifies 515 a candidate IP clusters that has been present in the retrieved activity logs for 3 to 7 days as a stable IP cluster. The ad system 150 may periodically monitor the activity logs to determine if a candidate IP cluster is a stable IP cluster. For example, if the client devices 110 included in a candidate IP clusters change within a period of time, the ad system 150 may determine that the candidate IP cluster is no longer a stable IP cluster.

The ad system 150 identifies 520 for each stable IP cluster a user of the online system 140 associated with the stable IP cluster. The ad system 150 may identify a user id associated with the client devices 110 included in a stable IP cluster, and determine from the identified user id the user of the online system 140 associated with the stable IP cluster. In another example, the ad system 150 may identify the user id included in the communications received from the client devices 110 behind the IP address associated with the IP cluster, and determine the user of the online system 140 associated with the IP cluster from the identified user id.

The ad system 150 validates 525 the identified stable IP clusters to confirm that the candidate IP clusters identified as stable IP clusters are indeed stable IP clusters. In one embodiment, the ad system 150 validates 525 the identified stable IP clusters based on the number of users of the online system 140 identified to be associated with each of the stable IP clusters. In one example, the ad system 150 may identify that more than a single user is associated with a stable IP cluster. The ad system 150 may no longer identify a stable IP cluster as a stable IP cluster if the ad system 150 determines that more than a single user is associated with the stable IP cluster. Alternatively, the ad system 150 may no longer identify a stable IP cluster as a stable IP cluster if the ad system 150 determines that greater than a threshold number of users is associated with the stable IP cluster. In another example, the ad system 150 may no longer determine that a stable IP cluster is a stable IP cluster if the identified user associated with the stable IP cluster changes over a period of time. For instance, the ad system 150 upon identifying that a first user is associated with a stable IP cluster for a first period of time and a second user is associated with the stable IP cluster for a second period of time, no longer considers the identified candidate cluster to be a stable IP cluster.

In another embodiment, the ad system 150 retrieves the activity log 455 maintained by the ad system 150 and validates 525 the stable IP clusters based on the information included in the ad system activity log 455. The ad system 150 identifies synced cookies associated with the client devices 110 of the stable IP cluster included in the ad system activity log 455. A synced cookie is a cookie received from a client device 110 that the ad system 150 and the online system 140 have identified to be associated with a specific user of the online system 140. The ad system 150 identifies the user of the online system 140 associated with the synced cookies received from the client devices 110 of the stable IP cluster and determines if the identified user associated with the synced cookie is the same user identified to be associated with the stable IP cluster. If the user associated with the synced cookies is not the same as the user associated with the stable IP cluster the ad system 150 determines that the stable IP cluster is no longer a stable IP cluster. In one example, if the ad system 150 identifies a plurality of users of the online system 140 associated with various synced cookies received from the client devices 110 of the stable IP cluster, the ad system 150 no longer identifies the stable IP cluster as a stable IP cluster.

The ad system 150 stores 530 an association between the user of the online system 140 associated with a stable IP cluster. In one embodiment, the ad system 150 stores 530 an association between the user id of the user and the stable IP cluster in the ad system activity log 455. The ad system 150 may also store 530 an association between the user id of the user and each client device 110 included in the stable IP cluster in the ad system activity log 455. This allows the ad system 150 to identify client devices 110 the user uses frequently. Further, the ad system 150 may also store an association between the traffic logged by the ad system 150 that is received from the client devices 110 included in the stable IP cluster and the user of the online system 140 associated with the stable IP cluster. In one embodiment, the ad system 150 may communicate the determined associations to the online system 140 to be stored and maintained by the online system 150.

### Identifying an Association Between an Unsynced Cookie and a User

FIG. 6 is a flowchart describing a method for identifying an association between an unsynced cookie and a user of a online system. The association between an unsynced cookie and a user of the online system 140 allows the ad system 150 and the online system 140 to identify a user associated with the unsynced cookie thereby converting the unsycned cookie into a synced cookie. As described below the method is performed by the ad system 150, however in other embodiments, the method may be performed by other entities such as the online system 140.

The ad system 150 retrieves 605 activity logs from the online system activity log 420 and the ad system 150 activity log 455. In particular, the ad system 150 retrieves 605 IP address information, client device 110 identifier information, and time information associated with the IP address information and client device 110 identifiers included in the online system activity log 420. Further, the ad system 150 also retrieves the user id associated with each communication from a client device 110 behind an IP address from the online system activity log 420. Similarly the ad system 150 retrieves 605 IP address information, client device 110 identifier information, and time information associated with the IP address information and client device 110 identifiers included in the ad system activity log 455. The ad system 150 also retrieves 605 information identifying the unsynced cookie (such as the unsynced cookie id) associated with each communication from a client device 110 behind an IP address from the ad system activity log 455.

The ad system 150 identifies 610 IP sequences associated with users of the online system 140 based on the retrieved online system activity log 420. The user IP sequence represents the times at which the users communicated with the online system 140 via a specific IP address over a given period of time. For example, the ad system 150 identifies 610 for each IP address the occurrences of communications associated with user ids of the users of the online system 140, including the time at which each communication associated with a user id was received and the client device 110 identifier associated with the client device 110 from which the communication was received. Thus, the user IP sequence is a sequence of user id occurrences, wherein each user id occurrence is associated with a time at which a communication associated with the user id was received. The user IP sequence may include multiple occurrences of a single user's user id over a given time period. For example, the user IP sequence may include multiple occurrences of a single user id during the time period of a day.

Similarly, the ad system 150 identifies 615 the IP sequences associated with unsynced cookies received by the ad system 150 based on the retrieved ad system activity log 455. The unsynced cookie IP sequence represents the times at which the unsynced cookies associated with a specific IP address were received by the ad system 150 over a given period of time. For example, the ad system 150 identifies for each IP address the occurrences of communications associated with unsynced cookie ids including the time at which each communication associated with an unsynced cookie id was received and the client device 110 identifier associated with the client device 110 from which the communication was received. Thus, the unsynced cookie IP sequence is a sequence of unsynced cookie id occurrences, wherein each unsynced cookie id occurrence is associated with a time at which a communication associated with the unsynced cookie id was received. The unsynced cookie IP sequence may include multiple occurrences of a single unsynced cookie id over a given time period. For example, the unsynced cookie IP sequence may include multiple occurrences of a single unsynced cookie id during the time period of a day.

In one embodiment, the ad system 150 in addition to identifying a user IP sequence and an unsynced cookie IP sequence generates 620 an overlap IP sequence. The overlap IP sequence is a combination of the user IP sequence and the unsynced cookie IP sequence over a given period of time. For example, the ad system 150 may combine or join the user IP sequence data and the unsynced cookie IP sequence data collected over the period of a specific day.

The ad system 150 determines 625 an overlap score based on the generated 620 overlap IP sequence. The overlap score 625 determines how closely the unsynced cookie is associated with a user of the online system 140. In one embodiment, the ad system 150 determines 625 the overlap score based on the number of times an unsynced cookie id and a user id co-occur on the same IP address during a given time period. For example, the ad system 150 determines 625 the overlap score by determining the number of times a user id and an unsynced cookie id co-occurred in the overlap IP sequence during a time period of a day.

In another embodiment, the ad system 150 may determine 625 a weighted overlap score based on the generated overlap IP sequence. In one example, the ad system 150 weights or modifies the overlap score based on the number of users of the online system 140 associated with the IP address within the time period of the overlap IP sequence. For example, if the overlap score is determined 625 based on the number of times a user id and an unsynced cookie id co-occurred in the overlap IP sequence during the time period of a day, the ad system 150 modifies the overlap score determined 625 based on the number of distinct user ids present in the overlap IP sequence during the same time period of a day. The ad system 150 may increase the determined 625 overlap score if there are very few users of the online system 140 associated with the IP address during the given time period, and may decrease the determined 625 overlap score if there are a large number of users of the online system 140 associated with the IP address during the given time period.

In another example, the ad system 150 modifies the overlap score based on the co-occurrence of the user id and the unsynced cookie id within the same portion of the given time period of the overlap IP sequence within which the overlap score is determined. For example, the ad system 150 may modify the weight attributed to each co-occurrence of the user id and the unsynced cookie id in the overlap IP sequence if the co-occurrence occurred within the time span of an hour. In one instance the ad system 150 increases the value associated with a co-occurrence of the user id and the unsynced cookie id in the overlap sequence if the co-occurrence occurred within the time span of an hour. In another instance the ad system 150 decreases the value associated with a co-occurrence of the user id and the unsynced cookie id in the overlap sequence if the co-occurrence occurred outside of the time span of an hour. In one embodiment, the specified portion of the given time period within which the overlap score is determined is configurable and can be modified, by a user authorized by the ad system 150 for example.

In some examples, a combination of different factors may be used to modify the overlap score determined from the co-occurrence of the user id and the unsynced cookie id within a given time period in the overlap IP sequence. For example, the weight attributed to the overlap score is increased with the number of co-occurrences of the user id and unsynced cookie id that occur within the time span of an hour. Further, the weight attributed to the overlap score is decreased by the square of the number of distinct user ids that occur in the overlap IP sequence during the time period of a day.

In some embodiments, additional information from the activity log may be used to determine 625 an overlap score for a user id and cookie id pair. For example, in addition to including the time associated with a user id and a cookie id in the overlap IP sequence, the ad system 150 may also associate with each user id and cookie id in the overlap IP sequence a geo-location value specifying the location at which the client device 110 was when the communication to the ad system 150 or the online system 140 occurred. The ad system 150 may retrieve geo-location values from the activity log and associate with each user id value in the user IP sequence the geo-location from which the communication associated with the user id was received. The ad system 150 may similarly associate a geo-location value with each unsynced cookie id in the unsynced cookie IP sequence. The ad system 150 may modify the overlap score based on the geo-location values associated with the co-occurring user id and unsynced cookie id. For example, co-occurrences of the user id and the unsynced cookie id having the same geo-location value within the same portion of the time period within which the overlap score is determined may be attributed a certain weight. In another example, the ad system 150 may modify the overlap score based on the subsequent co-occurrences of the user id and the unsynced cookie id having the same geo-location value.

The ad system 150 determines 630 whether the unsynced cookie id and the user id are associated with one another based on the overlap score. For example, the ad system 150 determines 630 that the unsynced cookie (represented by the unsynced cookie id) and the user of the online system 140 (represented by the user id) are associated with on another if the overlap score is greater than a threshold value. In some embodiments, the ad system 150 may aggregate the overlap score over multiple periods of time and determine 630 that the unsynced cookie and the user of the online system 140 are associated with each other if the aggregated overlap score is greater than a threshold value. For example, the ad system 150 determines 630 the overlap score for a given time period of a day. The ad system 150 may continue to determine 630 the daily overlap score for multiple days and may generate an aggregated overlap score (by adding or taking an average of the daily overlap score over multiple days for example). The ad system 150 may then determine 630 that the unsynced cookie and the user of the online system 140 are associated with one another if the aggregated overlap score is greater than a threshold value.

The ad system 150 may store 635 an association between the unsynced cookie and the user of the online system 140 thereby generating a synced cookie associated with the user of the online system 140. In one embodiment, the ad system 150 stores 635 an association between the user id of the user and the unsynced cookie id associated with the unsynced cookie in the ad system activity log 455. The ad system 150 may also store 635 an association between the user and information associated with the unsynced cookie stored by the ad system 150. For example, the ad system 150 may store 635 an association between the user and a client device 110 associated with the unsynced cookie, web page viewing history associated with the unsynced cookie, and other user activity associated with the unsynced cookie. This allows the ad system 150 to identify client devices 110 the user uses that the online system 140 is unaware of or other information associated with a user the online system 140 of which the user is unaware.

In one embodiment, the ad system 150 may verify that the unsynced cookie and user of the online system 140 may be associated with one another prior to creating and storing an association between the unsynced cookie and the user. For example, the ad system 150 retrieves the client device 110 identifier associated with the unsynced cookie and one or more client device 110 identifiers associated with the user of the online system 140, and determines that the unsynced cookie and the user may be associated with one another if the client device 110 identifier associated with the unsynced cookie matches a client device 110 identifier associated with the user.

### Identifying an Association Between Two Cookies

FIG. 7 is a flowchart describing a method for identifying an association between two cookies received by the ad system. The association between two cookies allows the ad system 150 to determine whether two cookies are associated with the same user using multiple client devices 110. ad system As described below the method is performed by the ad system 150, however in other embodiments, the method may be performed by other entities such as the online system 140.

The ad system 150 retrieves 705 the ad system activity log 455. In particular, the ad system 150 retrieves IP address information, client device 110 identifier information, and time information associated with the IP address information and client device 110 identifiers included in the ad system activity log. The online system 140 also retrieves information identifying the cookie associated with each communication from a client device 110 behind an IP address from the ad system activity log.

The ad system 150 identifies 710 the IP sequences associated with cookies received by the ad system 150 based on the retrieved ad system activity log 455. The cookie IP sequence represents the times at which the cookies associated with a specific IP address were received by the ad system 150 over a given period of time. For example, the ad system 150 identifies for each IP address the occurrences of communications associated with cookie ids including the time at which each communication associated with a cookie id was received and the client device 110 identifier associated with the client device 110 from which the communication was received. Thus, the cookie IP sequence is a sequence of cookie id occurrences, wherein each cookie id occurrence is associated with a time at which a communication associated with the cookie id was received. Therefore, the cookie IP sequence may include multiple occurrences of a single cookie id over a given time period. For example, the cookie IP sequence may include multiple occurrences of a single cookie id during the time period of a day.

The ad system 150 determines 715 an overlap score based on the cookie IP sequence. The overlap score determines how closely two cookies are associated with one another and may possibly be associated with the same user. A user may use multiple client devices 110 within a given time period, or multiple applications on a single client device 110 within a given time period (such as multiple web browsers), thereby resulting in the ad system 150 receiving multiple cookies based on user activity associated with the same user. In one embodiment, the ad system 150 determines 715 the overlap score for a pair of cookies based on the number of times the two cookie ids associated with each cookie in the pair of cookies co-occur on the same IP address during a given time period. For example, the online system 140 determines 715 the overlap score by determining the number of times the two cookie ids co-occurred in the cookie IP sequence during a time period of a day.

In another embodiment, the online system 140 may determine 715 a weighted overlap score based on the cookie IP sequence. In one example, the online system 140 weights or modifies the overlap score based on the number of distinct cookies associated with the IP address within the time period of the cookie IP sequence. For example, if the overlap score is determined based on the number of times the two cookie ids co-occurred in the cookie IP sequence during the time period of a day, the ad system 150 modifies the overlap score determined based on the number of distinct cookie ids present in the cookie IP sequence during the same time period of a day. The ad system 150 may increase the determined overlap score if there are very few distinct cookies associated with the IP address during the given time period, and may decrease the determined overlap score if there are a large number of distinct cookies associated with the IP address during the given time period.

In another example, the ad system 150 modifies the overlap score based on the co-occurrence of the two cookie ids within the same portion of the given time period of the cookie IP sequence within which the overlap score is determined. For example, the ad system 150 may modify the weight attributed to each co-occurrence of the cookie ids in the cookie IP sequence if the co-occurrence occurred within the time span of an hour. In one instance the ad system 150 increases the value associated with a co-occurrence of the cookie ids in the cookie IP sequence if the co-occurrence occurred within the time span of an hour. In another instance the online system 140 decreases the value associated with a co-occurrence of the cookie ids in the cookie IP sequence if the co-occurrence occurred outside of the time span of an hour. In one embodiment, the specified portion of the given time period within which the overlap score is determined is configurable and can be modified, by a user authorized by the online system 140 for example.

In some examples, a combination of different factors may be used to modify the overlap score determined 715 from the co-occurrence of the cookie ids within a given time period in the cookie IP sequence. For example, the weight attributed to the overlap score is increased with the number of co-occurrences of the cookie ids that occur within the time span of an hour. Further, the weight attributed to the overlap score is decreased by the square of the number of distinct cookie ids that occur in the cookie IP sequence during the time period of a day.

In some embodiments, additional information from the activity log may be used to determine 715 the overlap score for the pair of cookies. For example, in addition to including the time associated with a cookie id in the cookie IP sequence, the ad system 150 may also associate with each cookie id in the cookie IP sequence a geo-location value specifying the location at which the client device 110 was when the communication to the ad system 150 including the cookie id occurred. The ad system 150 may retrieve geo-location values from the ad system activity log 455 and associate with each cookie id in the cookie IP sequence the geo-location from which the communication associated with the cookie id was received. The ad system 150 may modify the overlap score based on the geo-location values associated with the co-occurring cookie ids. For example, co-occurrences of the cookie ids having the same geo-location value within the same portion of the time period within which the overlap score is determined 715 may be attributed a certain weight. In another example, the online system may modify the overlap score based on the subsequent co-occurrences of the cookie ids having the same geo-location value.

The ad system 150 determines 720 whether the cookies are associated with one another based on the overlap score. For example, the ad system 150 determines 720 that the cookies are associated with on another if the overlap score is greater than a threshold value. In some embodiments, the ad system 150 may aggregate the overlap score over multiple periods of time and determine 720 that the two cookies are associated with each other if the aggregated overlap score is greater than a threshold value. For example, the ad system 150 determines the overlap score for a given time period of a day. The ad system 150 may continue to determine the daily overlap score for multiple days and may generate an aggregated overlap score (by adding or taking an average of the daily overlap score over multiple days for example). The ad system 150 may then determine that the two cookies are associated with one another if the aggregated overlap score is greater than a threshold value.

The ad system 150 verifies 725 the type of association inferred from determining an association between the two cookies. For example, the ad system 150 may infer based on the overlap score that the type of association between the two cookies is that the two cookies are associated with the same individual or user. In other examples, the ad system 150 may infer different types of associations between the two cookies such as whether the two cookies are associated with the same household, or whether the two cookies are associated with the same device frequently used by two different people. In one embodiment, the ad system 150 retrieves information from the online system 140 associated with the two cookies and verifies 725 the type of association inferred between the two cookies. For example, the ad system 150 determines based on information retrieved from the online system 140 whether the two cookies are associated with the same individual or user. For example, if both the cookies in the pair of cookies are synced cookies and are thus, each associated with a user of the online system 140, the ad system 150 may confirm that the pair of cookies belong to the same individual or user if the users associated with each cookie are the same. In the event that the users of the online system 140 associated with each of the cookies is not the same the ad system 150 may verify that the inference that the cookies are associated with the same individual is incorrect.

In some examples, only one of the two cookies may be a synced cookie. The ad system 150 may infer that both the cookies are associated with the same user and may create an association between the unsynced cookie and the user associated with the synced cookie. In the event that the ad system 150 determines that the two cookies are associated with different users of the online system 140 but have a high overlap score, the ad system 150 may infer that the two cookies are associated with the same household or individuals who frequently communicate over the same IP address during the same periods of time.

The ad system 150 stores 730 the association between the two cookies in the ad system activity log 455 for example. The ad system 150 may also store 730 an association between the cookies and information associated with each of the cookies such as information associated with each cookie stored in the ad system activity log 455 or information associated with each cookie retrieved from the online system 140 (e.g., information associated with the user of the online system associated with one or both of the cookies). The ad system 150 may also store 730 the type of association between the two cookies. For example, the ad system 150 may store an indicator in the ad system activity log 455 indicating that the two cookies are associated with the same individual or the two cookies are associated with the same household.

The above example discusses identifying an association between two cookies. However, in other embodiments, similar methods may be applied to identify an association between two identifiers, such as an association between a device identifier and a cookie, an association between a user identifier and a cookie, an association between two device identifiers, an association between two user identifiers, or an association between a device identifier and a user identifier.

### CONCLUSION

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method comprising:
retrieving one or more activity logs including information about user activities captured by an online system and an ad system;
generating, based on the one or more activity logs, an internet protocol (IP) sequence for an IP address, the IP sequence identifying a plurality of occurrences of a user identifier and a plurality of occurrences of an ad system identifier in communications identifying the IP address within a period of time, the user identifier identifying a user of the online system;
determining an overlap score based on a number of times the user identifier and the ad system identifier co-occur in the IP sequence within the period of time;
determining, based on the overlap score, an association between the ad system identifier and the user identifier; and
storing the association between the ad system identifier and the user identifier.

2. The method of claim 1, wherein generating, based on the one or more activity logs, the internet protocol (IP) sequence for the IP address, the IP sequence identifying the plurality of occurrences of the user identifier and the plurality of occurrences of the ad system identifier in communications identifying the IP address within the period of time comprises:
identifying a user IP sequence, based on the one or more activity logs, the user IP sequence identifying the plurality of occurrences of the user identifier in communications identifying the IP address within the period of time;
identifying an ad system IP sequence, based on the one or more activity logs, the ad system IP sequence identifying the plurality of occurrences of the ad system identifier in communications identifying the IP address within the period of time; and
generating the IP sequence based on the user IP sequence and the ad system IP sequence.

3. The method of claim 1, wherein determining the overlap score based on the number of times the user identifier and the ad system identifier co-occur in the IP sequence within the period of time further comprises:
identifying a number of distinct user identifiers included in the IP sequence; and
modifying the overlap score based on the number of identified distinct user identifiers.

4. The method of claim 1, wherein determining the overlap score based on the number of times the user identifier and the ad system identifier co-occur in the IP sequence within the period of time further comprises:
identifying a number of times the user identifier and ad system identifier co-occur in a specified time span within the period of time; and
modifying the overlap score based on the number of times the user identifier and ad system identifier co-occur in the specified time span within the period of time.

5. The method of claim 1, wherein determining the overlap score based on the number of times the user identifier and the ad system identifier co-occur in the IP sequence within the period of time further comprises:
identifying a user identifier geo-location value associated with each of the plurality of occurrences of the user identifier in the IP sequence, the user identifier geo-location value identifying a location from which a communication including the user identifier was received;
identifying an ad system identifier geo-location value associated with each of the plurality of occurrences of the ad system identifier in the IP sequence, the ad system identifier geo-location value identifying a location from which a communication including the ad system identifier was received;
identifying a number of co-occurrences of the user identifier and the ad system identifier in the IP sequence where the user identifier geo-location value associated with the occurrence of the user identifier and the ad system identifier geo-location value associated with the occurrence of the ad system identifier are the same; and
modifying the overlap score based on the number of co-occurrences.

6. The method of claim 1, wherein determining the overlap score based on the number of times the user identifier and the ad system identifier co-occur in the IP sequence within the period of time further comprises:
identifying a user identifier geo-location value associated with each of the plurality of occurrences of the user identifier in the IP sequence, the user identifier geo-location value identifying a location from which a communication including the user identifier was received;
identifying an ad system identifier geo-location value associated with each of the plurality of occurrences of the ad system identifier in the IP sequence, the ad system identifier geo-location value identifying a location from which a communication including the ad system identifier was received;
identifying a number of subsequent co-occurrences of the user identifier and the ad system identifier in the IP sequence where the user identifier geo-location value associated with the subsequent occurrence of the user identifier and the ad system identifier geo-location value associated with the subsequent occurrence of the ad system identifier are the same; and
modifying the overlap score based on the number of co-occurrences.

7. The method of claim 1, wherein determining, based on the overlap score, the association between the ad system identifier and the user identifier comprises:
determining, based on the overlap score being greater than a threshold value, the association between the ad system identifier and the user identifier.

8. The method of claim 1, wherein the ad system identifier is identifying an unsynced cookie maintained by the ad system, the unsynced cookie being a cookie that has not been determined to be associated with any particular user of the online system.

9. The method of claim 1, wherein the online system is a social networking system and the user identifier uniquely identifies the user as a particular user having a particular social networking user profile within the social networking system.

10. The method of claim 1, further comprising:
retrieving information about a client device associated with the user identifier;
retrieving information about a client device associated with the ad system identifier; and
verifying the association between the user identifier and the ad system identifier based on the information about the client device associated with the user identifier and the information about the client device associated with the ad system identifier.

11. The method of claim 1, further comprising:
generating, based on the one or more activity logs, a cookie IP sequence for a second IP address, the cookie IP sequence identifying a plurality of occurrences of a first cookie identifier and a second cookie identifier in communications identifying the second IP address within a period of time, the first cookie identifier identifying a first cookie maintained by the ad system and the second cookie identifier identifying a second cookie maintained by the ad system;
determining an overlap score based on a number of times the first cookie identifier and the second cookie identifier co-occur in the cookie IP sequence within the period of time;
determining, based on the overlap score, an association between the first cookie identifier and the second cookie identifier;
identifying a type of the determined association between the first cookie identifier and the second cookie identifier; and
storing the type of association between the first cookie identifier and second cookie identifier.

12. The method of claim 1, further comprising:
identifying, based on the one or more activity logs, a set of candidate IP clusters, a candidate IP cluster comprising a plurality of client devices associated with an IP address;
identifying a stable IP cluster from the set of candidate IP clusters;
identifying a user of the online system associated with the identified stable IP cluster; and
storing an association between the identified user of the online system and the plurality of devices associated with the stable IP cluster.

13. A computer program product comprising a computer-readable storage medium containing computer program code for:
retrieving one or more activity logs including information about user activities captured by a online system and an ad system;
generating, based on the one or more activity logs, an internet protocol (IP) sequence for an IP address, the IP sequence identifying a plurality of occurrences of a user identifier and a plurality of occurrences of an ad system identifier in communications identifying the IP address within a period of time, the user identifier identifying a user of the online system;
determining an overlap score based on a number of times the user identifier and the ad system identifier co-occur in the IP sequence within the period of time;
determining, based on the overlap score, an association between the ad system identifier and the user identifier; and
storing the association between the ad system identifier and the user identifier.

14. The computer program product of claim 13, wherein generating, based on the one or more activity logs, the internet protocol (IP) sequence for the IP address, the IP sequence identifying the plurality of occurrences of the user identifier and the plurality of occurrences of the ad system identifier in communications identifying the IP address within the period of time comprises:
identifying a user IP sequence, based on the one or more activity logs, the user IP sequence identifying the plurality of occurrences of the user identifier in communications identifying the IP address within the period of time;
identifying an ad system IP sequence, based on the one or more activity logs, the ad system IP sequence identifying the plurality of occurrences of the ad system identifier in communications identifying the IP address within the period of time; and
generating the IP sequence based on the user IP sequence and the ad system IP sequence.

15. The computer program product of claim 13, wherein determining the overlap score based on the number of times the user identifier and the ad system identifier co-occur in the IP sequence within the period of time further comprises:
identifying a number of distinct user identifiers included in the IP sequence; and
modifying the overlap score based on the number of identified distinct user identifiers.

16. The computer program product of claim 13, wherein determining the overlap score based on the number of times the user identifier and the ad system identifier co-occur in the IP sequence within the period of time further comprises:
identifying a number of times the user identifier and ad system identifier co-occur in a specified time span within the period of time; and
modifying the overlap score based on the number of times the user identifier and ad system identifier co-occur in the specified time span within the period of time.

17. The computer program product of claim 13, wherein determining the overlap score based on the number of times the user identifier and the ad system identifier co-occur in the IP sequence within the period of time further comprises:
identifying a user identifier geo-location value associated with each of the plurality of occurrences of the user identifier in the IP sequence, the user identifier geo-location value identifying a location from which a communication including the user identifier was received;
identifying an ad system identifier geo-location value associated with each of the plurality of occurrences of the ad system identifier in the IP sequence, the ad system identifier geo-location value identifying a location from which a communication including the ad system identifier was received;
identifying a number of co-occurrences of the user identifier and the ad system identifier in the IP sequence where the user identifier geo-location value associated with the occurrence of the user identifier and the ad system identifier geo-location value associated with the occurrence of the ad system identifier are the same; and
modifying the overlap score based on the number of co-occurrences.

18. The computer program product of claim 13, wherein determining the overlap score based on the number of times the user identifier and the ad system identifier co-occur in the IP sequence within the period of time further comprises:
identifying a user identifier geo-location value associated with each of the plurality of occurrences of the user identifier in the IP sequence, the user identifier geo-location value identifying a location from which a communication including the user identifier was received;
identifying an ad system identifier geo-location value associated with each of the plurality of occurrences of the ad system identifier in the IP sequence, the ad system identifier geo-location value identifying a location from which a communication including the ad system identifier was received;
identifying a number of subsequent co-occurrences of the user identifier and the ad system identifier in the IP sequence where the user identifier geo-location value associated with the subsequent occurrence of the user identifier and the ad system identifier geo-location value associated with the subsequent occurrence of the ad system identifier are the same; and
modifying the overlap score based on the number of co-occurrences.

19. The computer program product of claim 13, wherein determining, based on the overlap score, the association between the ad system identifier and the user identifier comprises:
determining, based on the overlap score being greater than a threshold value, the association between the ad system identifier and the user identifier.

20. The method of claim 13, wherein the online system is a social networking system and the user identifier uniquely identifies the user as a particular user having a particular social networking user profile within the social networking system.

21. The computer program product of claim 13, wherein the ad system identifier identifying an unsynced cookie maintained by the ad system, the unsynced cookie being a cookie with which a user of the online system is not associated.

22. The computer program product of claim 13, further comprising computer code for:
retrieving information about a client device associated with the user identifier;
retrieving information about a client device associated with the ad system identifier; and
verifying the association between the user identifier and the ad system identifier based on the information about the client device associated with the user identifier and the information about the client device associated with the ad system identifier.

23. The computer program product of claim 13, further comprising computer code for:
generating, based on the one or more activity logs, a cookie IP sequence for a second IP address, the cookie IP sequence identifying a plurality of occurrences of a first cookie identifier and a second cookie identifier in communications identifying the second IP address within a period of time, the first cookie identifier identifying a first cookie maintained by the ad system and the second cookie identifier identifying a second cookie maintained by the ad system;
determining an overlap score based on a number of times the first cookie identifier and the second cookie identifier co-occur in the cookie IP sequence within the period of time;
determining, based on the overlap score, an association between the first cookie identifier and the second cookie identifier;
identifying a type of the determined association between the first cookie identifier and the second cookie identifier; and
storing the type of association between the first cookie identifier and second cookie identifier.

24. The computer program product of claim 13, further comprising computer code for:
identifying, based on the one or more activity logs, a set of candidate IP clusters, a candidate IP cluster comprising a plurality of client devices associated with an IP address;
identifying a stable IP cluster from the set of candidate IP clusters;
identifying a user of the online system associated with the identified stable IP cluster; and
storing an association between the identifier user of the online system and the plurality of devices associated with the stable IP cluster
